(19) United States
(12) Patent Application Publication
(10) Pub. No.: US 2026/0299299 A1
(43) Pub. Date: Oct. 1, 2026

(54) MULTIPLE SEPARATED FIELD OF VIEW AUGMENTED REALITY WAVEGUIDE SYSTEM

(71) Applicant: GOOGLE LLC, Mountain View, CA (US)

(72) Inventor: Thomas Hoekman, Redwood City, CA (US)

(21) Appl. No.: 19/477,016

(22) PCT Filed: Apr. 27, 2023
(86) PCT No.: PCT/US2023/020154

§ 371 Date: Oct. 20, 2025

(51) Int. Cl. G02B 27/01; G02B 27/00

(52) U.S. Cl. CPC G02B 27/0172; G02B 27/0081; G02B 2027/0112; G02B 2027/0123; G02B 2027/0178

(57) ABSTRACT

A waveguide system of an eyewear display device guides display light from a primary display to a primary field of view (FOV) and guides display light from a secondary display to a secondary FOV that is displaced from the primary FOV. Additional display light of a given color that is incoupled to the waveguide system at a different angle than the primary display light is outcoupled from the waveguide system at a corresponding angle displaced from the primary FOV to form a secondary FOV that is spatially displaced from the primary FOV in some embodiments.

### BACKGROUND

Augmented reality (AR) display systems typically utilize an optical combiner that combines light from the real world and light from a display, which may represent computer-generated imagery or recorded imagery, for output toward at least one eye of a user. One common type of optical combiner is a waveguide (also commonly referred to as a “lightguide”) used to transfer light from a light source (e.g., a projector or micro-display) toward a user's eye, while being substantially transparent to incident light from the surrounding environment. Display light from the light source enters the waveguide through an input coupler (referred to herein as an incoupler (IC)) and is propagated through the waveguide via total internal reflection (TIR) or other internal propagation techniques, and then is output toward the user's eye via an output coupler (referred to herein as an outcoupler (OC)). The outcoupler directs the light at an eye relief distance from the waveguide, forming an exit pupil within which a virtual image generated by the image source can be viewed within a field of view (FOV) by a user of the display device.

### SUMMARY OF EMBODIMENTS

A near-eye display system includes a waveguide system and two displays.

The first display emits display light of a first color that enters a waveguide system at a first set of input angles corresponding to a first field of view. The second display is displaced from the first display and emits display light of a second color that enters the waveguide system at a second set of input angles corresponding to a second field of view. The waveguide system directs display light from the first display to the first field of view and directs display light from the second display to the second field of view.

In some embodiments, the first field of view is displaced from the second field of view. The second display may be configured to emit display light of the first color and the second color. In some embodiments, the waveguide system includes two waveguides. A first waveguide guides display light from the first display to the first field of view and guides display light from the second display to the second field of view. A second waveguide guides display light from the first display to the first field of view.

The waveguide system may include two incouplers. A first incoupler may direct display light from the first display into the waveguide system and a second incoupler displaced from the first incoupler may direct display light from the second display into the waveguide system. The waveguide system may include an outcoupler to couple display light from the first incoupler and the second incoupler out of the waveguide system.

In some embodiments, the first incoupler and the second incoupler are one-dimensional gratings and the outcoupler is a two-dimensional grating that expands display light from the first incoupler and the second incoupler and couples the display light out of the waveguide system. The near-eye display system may also include a reticle disposed between the first display and the waveguide system to add information to the display light.

In another embodiment, a method includes emitting display light of a first color from a first display to enter a waveguide system at a first set of input angles corresponding to a first field of view. The method also includes emitting display light of a second color from a second display to enter the waveguide system at a second set of input angles corresponding to a second field of view. The method further includes directing display light from the first display through the waveguide system to the first field of view and directing display light from the second display through the waveguide system to the second field of view.

In some embodiments, the first field of view is displaced from the second field of view. The method may also include emitting display light of the first color from the second display.

In some embodiments, the method includes directing display light from the first display and the second display into a first waveguide of the waveguide system through a first incoupler, coupling display light from the first display out of the first waveguide through a first outcoupler to the first field of view, and coupling display light from the second display out of the first waveguide through the first outcoupler to the second field of view. The method may also include directing display light from the first display into a second waveguide of the waveguide system through a second incoupler and coupling display light out of the second waveguide through a second outcoupler to the first field of view.

The method may also include directing display light from the first display into the waveguide system through a first incoupler and directing display light from the second display into the waveguide system through a second incoupler that is displaced from the first incoupler. The method may also include coupling display light from the first incoupler and the second incoupler out of the waveguide system through an outcoupler.

In some embodiments, a waveguide system includes a waveguide to direct primary display light from a primary display to a primary field of view and to direct secondary display light from a secondary display to a secondary field of view offset from the primary field of view. The primary display light may include red light, green light, and blue light, and the secondary display light may include only one of red light, green light, and blue light.

The waveguide system may include a first waveguide configured to direct green and blue display light from the primary display to the primary field of view and direct red display light from the secondary display to the secondary field of view. The waveguide system may also include a second waveguide configured to direct red display light from the primary display to the primary field of view.

The waveguide system may also include a first incoupler to direct the primary display light from the primary display into the waveguide system and a second incoupler displaced from the first incoupler to direct the secondary display light from the secondary display into the waveguide system. The waveguide system may include an outcoupler to couple the primary and secondary display light from the first incoupler and the second incoupler out of the waveguide system.

In some embodiments, the first incoupler and the second incoupler are one-dimensional gratings and the outcoupler is a two-dimensional grating that expands the primary display light from the first incoupler and the second incoupler and couples the primary display light out of the waveguide system.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a rear perspective view of an AR near-eye display system utilizing a waveguide system that directs display light from a first display to a first field of view display light from a second display to a second field of view in accordance with some embodiments.

FIG. 2 is a diagram illustrating a primary field of view and locations of secondary fields of view in relation to a lens in accordance with some embodiments.

FIG. 3 is a diagram illustrating the rear view of the lens of FIG. 2 with a projection of component wavelengths of display light traveling between an incoupler, an exit pupil expander, and an outcoupler of a waveguide of FIGS. 2-4 in accordance with some embodiments.

FIG. 4 is a diagram illustrating the rear view of the lens of FIG. 2 with a dual waveguide system in accordance with some embodiments.

FIG. 5 illustrates k-space diagrams of the component wavelengths of display light traveling through the waveguide systems of FIGS. 3 and 4 in accordance with some embodiments.

FIG. 6 is a k-space diagram of the component wavelengths of display light traveling through the waveguide of FIG. 4 in accordance with some embodiments.

FIG. 7 illustrates two rear views of the lens of FIG. 2 with projection of component wavelengths of display light traveling between a one-dimensional incoupler and a two-dimensional outcoupler in accordance with some embodiments.

FIG. 8 is a k-space diagram of the component wavelengths of display light traveling through the waveguides of FIG. 7 in accordance with some embodiments.

FIG. 9 is a diagram illustrating display light projected from two displays through projection lens optics to two separate exit pupils in accordance with some embodiments.

### DETAILED DESCRIPTION

Near-eye display systems such as eyewear display devices potentially have multiple practical and leisure applications, but the development and adoption of wearable electronic display devices have been limited by constraints imposed by the optics, aesthetics, manufacturing process, thickness, field of view (FOV), and prescription lens limitations of the optical systems used to implement existing display devices. For example, the geometry and physical constraints of conventional designs result in displays having relatively small FOVs and relatively thick optical combiners.

Different wavelengths of light propagate through a waveguide via TIR at different angles. Light is only able to propagate through the waveguide via total internal reflection (TIR) at a limited number of discrete propagation angles (i.e., polar angles), such that all three colors of display light are able to successfully propagate through the waveguide to be output to the eye of a user for only a limited FOV. To propagate all three colors (red, blue, and green (RGB)) of the visible spectrum through a single waveguide to a relatively large FOV, some waveguide architectures employ high refractive index glass or other substrate material for both the waveguide and the waveguide gratings. An increase in FOV might also be associated with an increase in size to meet performance requirements.

The size of the field of view of an AR display system is limited by the k-space volume of the display system. The k-space diagram is a tool used in optical design to represent directions of light rays that propagate within a waveguide. Its horizontal and vertical axes represent the x and y (horizontal and vertical) basis vectors on the surface of the waveguide. A point in k-space represents the direction cosines of a ray within the waveguide, scaled by the refractive index of the medium in which they propagate. The k-space volume can be increased by using higher refractive index materials for the waveguide, but such solutions are expensive. For a single waveguide, the incoupler grating to a diffractive waveguide diffracts light with different wavelengths to different regions of k-space. Red light is pushed the farthest in the k-space volume, and blue light is pushed the least. To carry all three RGB colors in a single waveguide to a single FOV, the refractive index of the waveguide materials must be increased (which impacts cost).

Typical AR display systems employ a single FOV to display all content and user interface (UI) elements. However, AR content is often sparse, such that in many use cases only a small portion of the FOV is used. When all content is clustered in the single FOV of a waveguide (which is smaller than the human field of vision), a user has a less immersive experience with the AR display system. Ideally, different types of content and UI elements are displayed in different areas of the natural field of vision of a human. For example, a camera recording indicator that is placed in the upper right corner of the user's field of vision can create a more immersive user experience. Similarly, subtitles and closed captioning shown in the bottom field of vision are easy to follow and reminiscent of the placement of subtitles and closed captioning in other display systems. In addition, navigation arrows that are placed closer to the center of the field of vision but at slightly negative or positive vertical angle offsets are conducive to a more immersive user experience.

A waveguide system designed to propagate all three RGB colors (or two GB colors) has the capacity to carry additional monochromatic light that is input to the waveguide system at a different set of input angles than the RBG or GB light. For example, in a typical 1D diffractive waveguide combiner design, red light that is input at a more positive angle than the RGB light can be carried by the same waveguide system to a wider output angle. Although corresponding blue or green light could not be output to the same viewing region without increasing the refractive index of the waveguide, additional red light that is input into the waveguide at the wider angle could be used in a secondary field of view above and to the right of the primary RGB field of view. Alternatively, or in addition, additional green or blue light that is input into the waveguide at a more negative angle could be used in a secondary field of view below and to the left of the primary RGB field of view. By adding an additional single-color display (light source), an eyewear display device can add content for the secondary field of view.

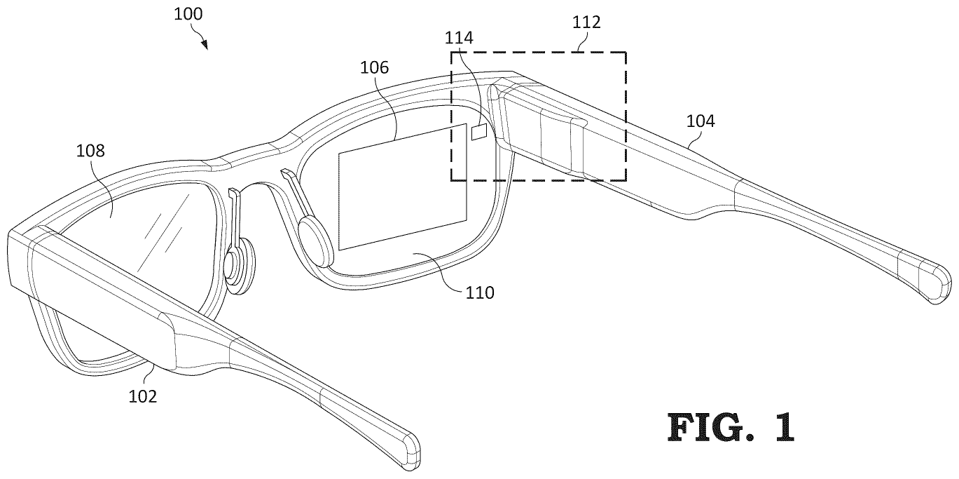

FIGS. 1-9 illustrate techniques for guiding RGB display light from a primary display through a waveguide system to a primary FOV and guiding display light of one color from a secondary display through the waveguide system to a secondary FOV that is displaced from the primary FOV. By proper design of the waveguide system, the sum of grating k-vectors is zero, resulting in a condition where the output angle of any ray extracted to the user's eye from the outcoupler will be equal to that of the specular reflection of the ray's initial incidence angle on the incoupler-this is colloquially known as a “closed loop in k-space”. Additionally, because the path of light propagating through the waveguide is dependent on both its incident angle, or alternatively its incident k-vector, as well as its wavelength, it is possible for additional display light in-coupled from outside the primary FOV to have similar paths as rays of a different wavelength that are incoupled from within the primary FOV. In some embodiments, the waveguide system includes a first waveguide to propagate the RGB display light to the primary FOV and a second waveguide to propagate the secondary display light to the secondary FOV. In other embodiments, the waveguide system includes a single waveguide with an incoupler (IC), exit pupil expander (EPE), and outcoupler (OC) (or, in some embodiments, a combined EPE/OC) that are sized to accommodate both the primary FOV and the secondary FOV. In other embodiments, the waveguide system includes a first waveguide to propagate the GB display light to the primary FOV and the R light to a secondary FOV, as well as a second waveguide to propagate the R light to a primary FOV and BG secondary display light to the secondary FOV. In yet other embodiments, light from the primary display is coupled into a single waveguide of the waveguide system through a first one-dimensional (1D) IC to a two-dimensional (2D) combined EPE/OC to the primary FOV and light from the secondary display is coupled into the single waveguide of the waveguide system through a second 1D IC to a 1D EPE and then through the 2D combined EPE/OC to the secondary FOV.

In some embodiments, the secondary display is a light source such as a light emitting diode (LED) that emits unmodulated red light and the secondary FOV is an indicator spatially displaced from the primary FOV (i.e., outside the periphery of the primary FOV) that indicates information such as that a camera of the eyewear display device is recording. In other embodiments, a reticle or mask is placed between the secondary display and the waveguide system to add information to the unmodulated red light, such as an icon or one or more words. In yet other embodiments, the secondary display is a micro-display that emits modulated red light. In embodiments in which the secondary display emits red light, the secondary FOV is generally located in an upper right quadrant of a lens of the eyewear display device. In other embodiments, the secondary display is a light source that emits green or blue light. In such embodiments, the secondary FOV is generally located in a lower left quadrant of a lens of the eyewear display device.

FIG. 1 illustrates an example AR display system 100 implementing a waveguide system to carry RGB display light to a primary FOV and secondary display light having a single color to a secondary FOV in accordance with implementations. The AR display system 100 includes a support structure 102 (e.g., a support frame) to mount to a head of a user and that includes an arm 104 that houses a laser projection system, micro-display (e.g., micro-light emitting diode (LED) display), or other light engine configured to project RGB display light representative of images toward the eye of a user, such that the user perceives the projected display light as a sequence of images displayed in a primary field of view (FOV) area 106 at one or both of lens elements 108, 110 supported by the support structure 102. The support structure 102 further houses an additional display (e.g., a light source or micro-LED display) configured to project monochromatic display light toward the eye of a user, such that the user perceives the projected monochromatic display light as an indicator or image displayed in a secondary FOV area 114 at one or both of lens elements 108, 110.

In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. The support structure 102 further can include one or more batteries or other portable power sources for supplying power to the electrical components of the AR display system 100. In some embodiments, some or all of these components of the display system 100 are fully or partially contained within an inner volume of support structure 102, such as within the arm 104 in region 112 of the support structure 102. In the illustrated implementation, the AR display system 100 utilizes a spectacles or eyeglasses form factor. However, the AR display system 100 is not limited to this form factor and thus may have a different shape and appearance from the eyeglasses frame depicted in FIG. 1.

One or both of the lens elements 108, 110 are used by the AR display system 100 to provide an AR display in which rendered graphical content can be superimposed over or otherwise provided in conjunction with a real-world view as perceived by the user through the lens elements 108, 110. For example, laser light or other display light is used to form a perceptible image or series of images that are projected onto the eye of the user via one or more optical elements, including a waveguide system, formed at least partially in the corresponding lens element. One or both of the lens elements 108, 110 thus includes at least a portion of a waveguide of the waveguide system that routes display light received by an incoupler (IC) (not shown in FIG. 1) of the waveguide to an outcoupler (OC) (not shown in FIG. 1) of the waveguide, which outputs the display light toward an eye of a user of the display system 100. Additionally, the waveguide employs an exit pupil expander (EPE) in the light path between the IC and OC (or in combination with the OC) in order to increase the dimensions of the display exit pupil. Moreover, each of the lens elements 108, 110 is sufficiently transparent to allow a user to see through the lens elements to provide a field of view of the user's real-world environment such that the image appears superimposed over at least a portion of the real-world environment.

In some embodiments, the display light is emitted by a digital light processing-based projector, a scanning laser projector, or any combination of a modulative light source, such as a laser or one or more light-emitting diodes (LEDs), and a dynamic reflector mechanism such as one or more dynamic scanners, reflective panels, or digital light processors (DLPs). In some embodiments, the display light is emitted by a micro-display panel, such as a micro-LED display panel (e.g., a micro-AMOLED display panel, or a micro inorganic LED (i-LED) display panel) or a micro-Liquid Crystal Display (LCD) display panel (e.g., a Low Temperature PolySilicon (LTPS) LCD display panel, a High Temperature PolySilicon (HTPS) LCD display panel, or an In-Plane Switching (IPS) LCD display panel). In some embodiments, the display light is emitted by a Liquid Crystal on Silicon (LCOS) display panel. In some embodiments, a display panel (referred to as a display) is configured to output display light (representing an image or portion of an image for display) into the waveguide system of the AR display system 100. The waveguide system expands the light and outputs the light toward the eye of the user via an outcoupler.

The display is communicatively coupled to a controller and a non-transitory processor-readable storage medium or memory storing processor-executable instructions and other data that, when executed by the controller, cause the controller to control the operation of the display. In some embodiments, the controller is communicatively coupled to one or more processors (not shown) that generate content to be displayed at the AR display system 100. The projector outputs light toward the FOV area 106 of the AR display system 100 via the waveguide system. In some embodiments, at least a portion of an outcoupler of the waveguide system overlaps the FOV area 106.

In at least one embodiment, the additional display such as a light source or micro-display emits monochromatic light (e.g., either red light or blue light or green light) that is received by the waveguide system and is output by the waveguide system to the secondary FOV area 114 that is spatially offset from the primary (RGB) field of view area 106. In some embodiments, the additional monochromatic display light is carried to the secondary FOV area 114 by the same waveguide system elements (e.g., IC, EPE, OC) that carry the RGB display light to the primary FOV area 106. In other embodiments, additional waveguide system elements (e.g., a separate waveguide, or a separate IC and EPE) carry the additional monochromatic display light to the secondary FOV area 114.

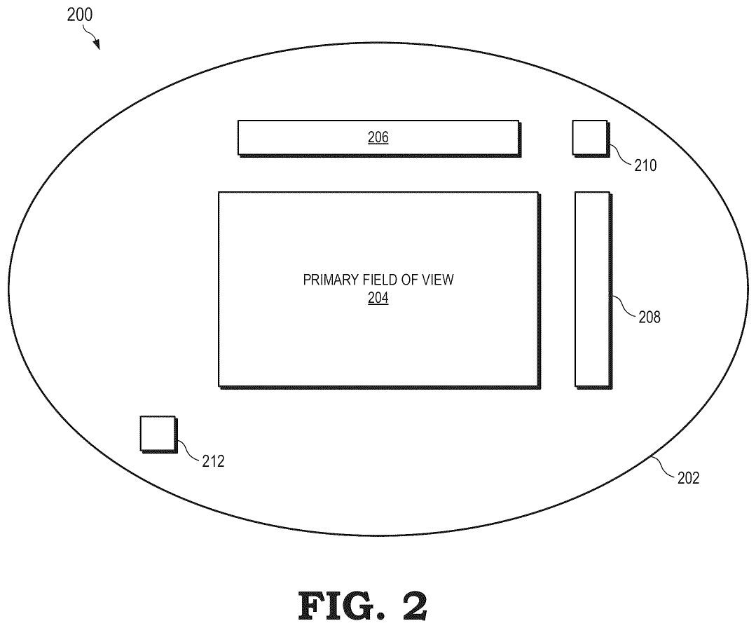

FIG. 2 is a diagram 200 illustrating a primary field of view 204 and locations of secondary fields of view 206, 208, 210, 212 in relation to a lens 202 in accordance with some embodiments. Unlike a conventional AR display system in which all content and UI elements are clustered to fit within a single primary FOV, such as FOV 204, the addition of a display configured to emit a narrow range of wavelengths of display light (e.g., red light or, in some embodiments, blue or green light) allows the additional display light to be directed to a secondary FOV that is displaced from the primary FOV 204.

For example, red light from an additional display is directed to secondary FOV 206 above the primary FOV 204 in some embodiments to display a status or navigation bar. In other embodiments, red light from the additional display is directed to secondary FOV 208 to the right of the primary FOV 204, where the red light is displayed as a side bar of information. In some embodiments, red light from the additional display is directed to secondary FOV 210 in the upper right corner of the lens 202, where the red light is displayed as an indicator or notification of, e.g., a low battery level or that a camera is recording. In other examples, the additional display emits green or blue light and is directed to secondary FOV 212 in the lower left corner of the lens 202.

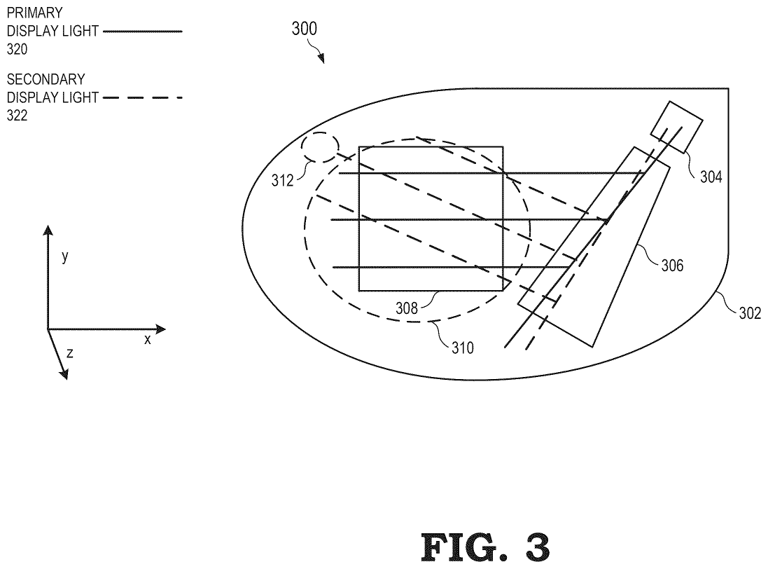

FIG. 3 illustrates an example of behavior of component wavelengths of primary (GB or RGB) display light and secondary (e.g., red) display light traveling through a single waveguide of a waveguide system within the lens element 110. FIG. 3 shows a waveguide system 300 within the rear view of a lens 302 with a projection of component wavelengths of primary and secondary display light traveling between an incoupler 304, an exit pupil expander 306, and an outcoupler 308 of the waveguide system 300 of in accordance with some embodiments. In the illustrated example, light from the primary FOV source (primary display light 320) and light from the secondary FOV source (secondary display light 322) are both guided through the same IC 304, EPE 306, and OC 308 of the waveguide system 300. Primary display light 320 propagates into the waveguide system 300 via the incoupler 304 to the EPE 306, and then out of the waveguide system 300 to a primary FOV 310. Secondary display light 322 (i.e., red light emitted from a secondary display) propagates into the waveguide system 300 via the incoupler 304 at a set of input angles offset from the set of input angles of the primary display light to the EPE 306, and then out of the waveguide system 300 to a secondary FOV 312 that is offset from the primary FOV 310. In some embodiments, the secondary FOV 312 displays content such as the current time, battery life, application indicators, or a camera recording indicator, etc. Cost and weight of the AR display system are reduced by directing both the primary and secondary display light through a single waveguide to the multi-color primary FOV 310 and monochromatic secondary FOV 312.

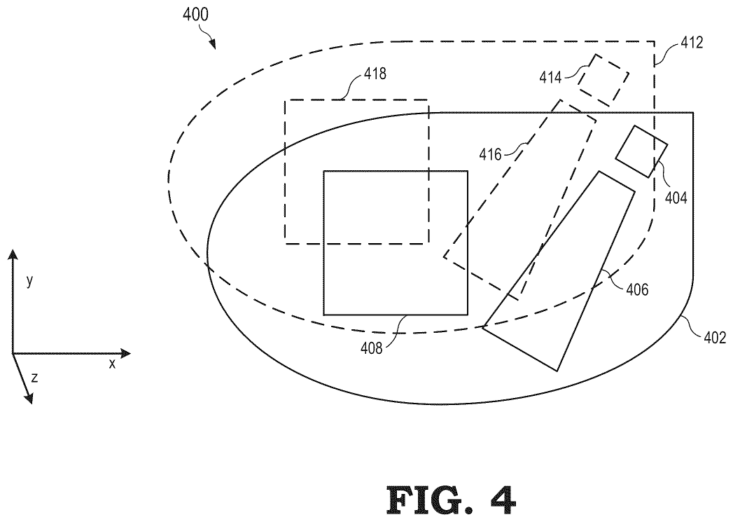

FIG. 4 is a diagram illustrating dual waveguide system 400 in accordance with some embodiments. In some embodiments, blue and green light from the primary FOV source propagates into a first waveguide 402 of the waveguide system 400 via an IC 404 to an EPE 406, and then out of the dual waveguide system 400 to the primary FOV (not shown) via an OC 408. Red light from the secondary FOV source input at a different set of input angles from the blue and green light also propagates into the first waveguide 402 via the IC 404 to the EPE 406 and then out of the dual waveguide system 400 to a secondary FOV (not shown) that is offset from the primary FOV via the OC 408. In some embodiments, red display light from the primary FOV source propagates into the second waveguide 412 of the waveguide system 400 via the IC 414 to the EPE 416, and then out of the dual waveguide system 400 via the OC 418 to the primary FOV (not shown). Thus, the red channel of the primary FOV is carried by the second waveguide 412, while the blue and green channels are carried by the first waveguide 402, along with the secondary red FOV.

In other embodiments, light from the primary FOV source (e.g., RGB light) propagates into the first waveguide 402 of the waveguide system 400 via the IC 404 to the EPE 406, and then out of the waveguide system 400 to the primary FOV (not shown) via the OC 408. Light from the secondary FOV source (e.g. red light) propagates into the second waveguide 412 of the waveguide system 400 via the IC 414 to the EPE 416, and then out of the dual waveguide system 400 via the OC 418 to the secondary FOV (not shown). In some embodiments, to avoid cross-talk between the images in each FOV, the ICs 404, 414 are spatially separated from each other. In yet other embodiments, the first waveguide 402 guides RBG light emitted from the primary display to the first FOV and the second waveguide 412 guides RGB light emitted from the secondary display to the secondary FOV.

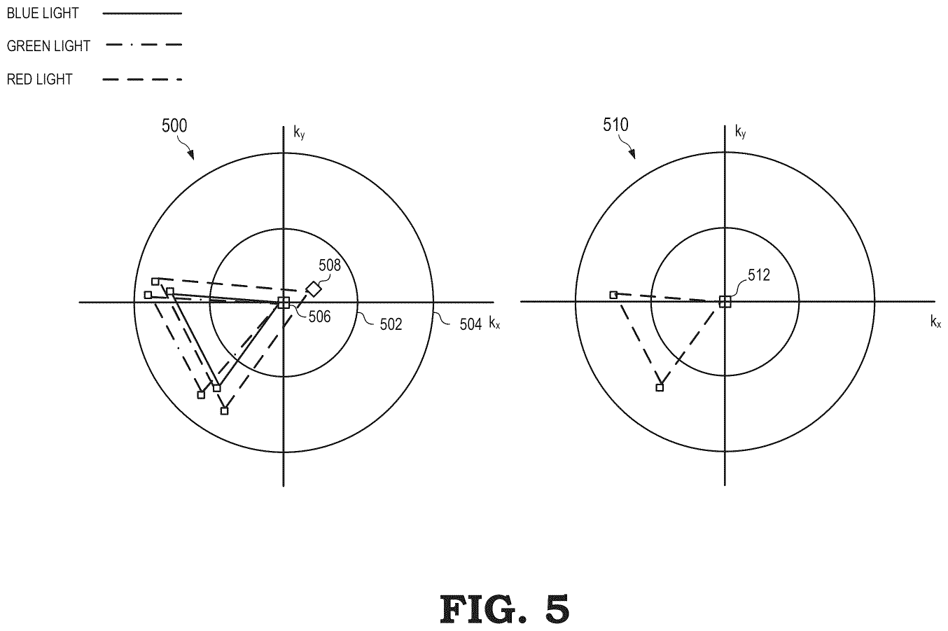

FIG. 5 illustrates normalized k-space representations 500, 510 of the component wavelengths of the primary and secondary display light (such as primary display light 320 and secondary display light 322) propagating through the waveguide system 400. The k-space diagram is a tool used in optical design to represent directions of light rays that propagate within a waveguide. Its horizontal and vertical axes represent the x and y (horizontal and vertical) components of ray directions relative to the user's eye. In the k-space representation 500, an inner refractive boundary 502 is depicted as a circle with radius of n=1, the refractive index associated with the external transmission medium (air); outer refractive boundary 504 corresponds to a refractive index of the diffractive waveguide system 400 of FIG. 4.

In the context of the k-space representation 500, for RGB display light of the primary display (e.g., full-color AR content) to be successfully and accurately directed to an eye of a user via a waveguide (such as diffractive waveguide system 300 or 400) with the indicated refractive index, each red, green, and blue component of that primary display light 320 enters the waveguide system from an external position 506, which is included in the space depicted within inner refractive boundary 502. The color components are directed along one or more paths within the waveguide system via total internal reflection (TIR) (light that undergoes TIR within the waveguide resides in the space depicted between inner refractive boundary 502 and outer refractive boundary 504) and are then redirected to exit the waveguide (and thereby return to the external space within inner refractive boundary 502 within which light does not undergo TIR). Display light components represented between the inner refractive boundary 502 and outer refractive boundary 504 are propagated to the user via the waveguide system. Any display light components represented outside the outer refractive boundary 504 (of which there are none in the k-space representation 500) are non-propagating and cannot exist.

Initially, primary display light 320 entering the waveguide system at the incoupler (e.g., IC 304) forms an image that is centered at or around the origin of the k-space representation 500. The image is initially disposed at a first position 506 with respect to k-space. Upon redirection of the primary display light 320 by the incoupler 304, the image is shifted in k-space to a second position, corresponding to a shift in the negative k_{y} and kₓ dimensions. Upon redirection of the primary display light 320 by the exit pupil expander (e.g., EPE 306), the image is shifted in k-space to a third position, corresponding to a shift in the positive k_{y} dimension and the negative kₓ dimension. Upon redirection of the primary display light 320 by the outcoupler (e.g., OC 308), the image is shifted in k-space back to the first position 506, corresponding to a shift in the positive kₓ dimension. In the present example, it is assumed that the angle at which the primary display light 320 enters the waveguide system via the IC 304 is the same as or substantially the same as (e.g., within 5% of) the angle at which the primary display light 320 exits the waveguide via the OC 308.

In the illustrated k-space representation 500, red light from the secondary display enters the waveguide system 300 from an angle in a non-guided or free space mode, referred to herein as an external position 508 in k-space, which is offset from the primary FOV angles represented at external position 506 (i.e., at an input angle that is offset upward and to the right from the input angle of the primary display light) and is included in the space depicted within inner refractive boundary 502. The red light is directed along a path within a volume of the waveguide system and is then redirected to exit the waveguide system and return to the external space within the refractive boundary 502 at an area (i.e., at angles corresponding to the input angle) that is offset from the primary display light. In embodiments in which the secondary display light is blue or green, the input angle is offset downward and to the left of the input angle of the primary display light.

In dual waveguide embodiments in which a first waveguide carries blue and green light for a primary FOV and red light for a secondary FOV, while a second waveguide carries red light emitted by the primary display for the primary FOV, a second k-space representation 510 illustrates red light carried by the second waveguide for the primary FOV entering the waveguide system 400 at an external position 512.

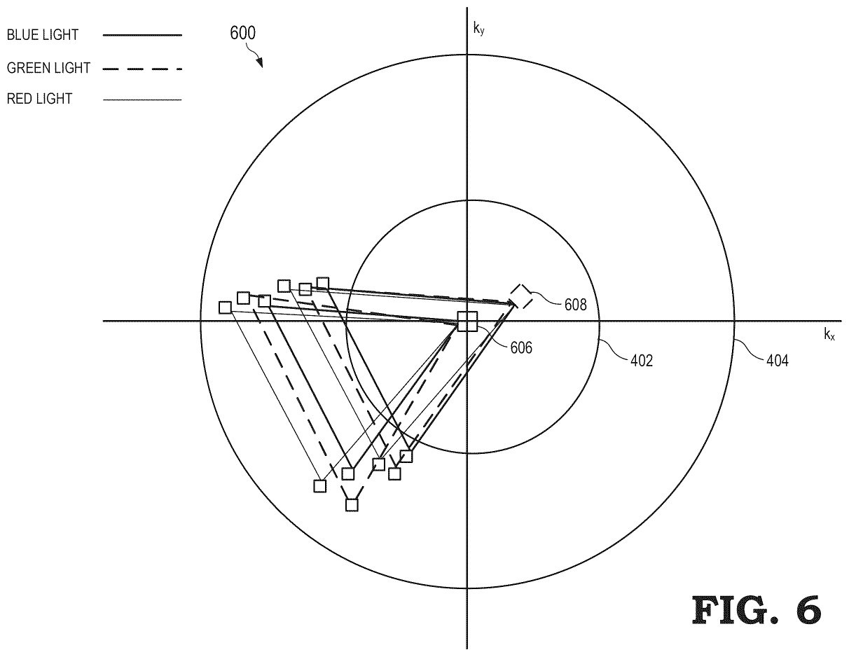

FIG. 6 illustrates a normalized k-space representation 600 of the component wavelengths of the primary and secondary display light propagating through the double waveguide system 400 in which the first waveguide 402 carries RGB display light to a first FOV and the second waveguide 412 carries RGB display light to a second FOV. Primary display light enters the dual waveguide system 400 from a point 606 in k-space which is included in the space depicted within inner refractive boundary 602. The color components are directed along one or more paths within the region in k-space between inner refractive boundary 602 and outer refractive boundary 604 through which rays have angles that can be TIRed and are then redirected to exit the dual waveguide system (and thereby return to the external space within inner refractive boundary 602). The three angles at which a ray travels when propagating through the dual waveguide system 400 are k0, k0+k_IC, and k0-k_OC (which is equal to K0+k_IC+k_EPE for that wavelength). Display light components represented between the inner refractive boundary 602 and outer refractive boundary 604 are propagated to the user via the dual waveguide system 400.

In the illustrated example, display light from the secondary display enters the dual waveguide system 400 from an external position 608 which is offset from the external position 606 and is included in the space depicted within inner refractive boundary 602. The secondary display light is directed along one or more paths within a volume of the double waveguide system and is then redirected to exit the dual waveguide system and return to the external space within the refractive boundary 602 at an area offset from the primary display light. In the illustrated example, the dual waveguide system 400 supports RGB light from the primary display to be directed through the first waveguide 402 to the primary FOV and RGB light from the secondary display to be directed through the second waveguide 412 to the secondary FOV. In such embodiments, placement of the secondary FOV within the user's FOV is unconstrained in comparison to the single waveguide system 300, which supports a red light secondary FOV above and to the right of the primary FOV and/or a green or blue light secondary FOV to the lower left of the primary FOV.

In some embodiments, the waveguide system directs both primary and secondary display light into the waveguide via a shared one-dimensional (1D) IC and expands and outcouples the light via a shared two-dimensional (2D) combination EPE/OC. In some embodiments, the waveguide system includes an additional 1D IC and 1D EPE to support the secondary FOV, but both the primary and secondary display light is outcoupled via a shared 2D EPE/OC. A 1D grating has grating structures that are periodic in one direction and diffracts light in one direction, and a 2D grating has grating structures that are periodic in two directions and diffract light in any linear combination of these two directions. For 1D gratings, any of a variety of 1D grating structures may be used. For example, the 1D gratings can be formed from a high-index material and encapsulated with a low-index material, or vice versa. For 2D gratings, any of a variety of 2D grating structures may be employed. For example, the 2D gratings could be formed from an array of rectangular pillars, cylindrical pillars, or pillars of arbitrary shape or cross-section.

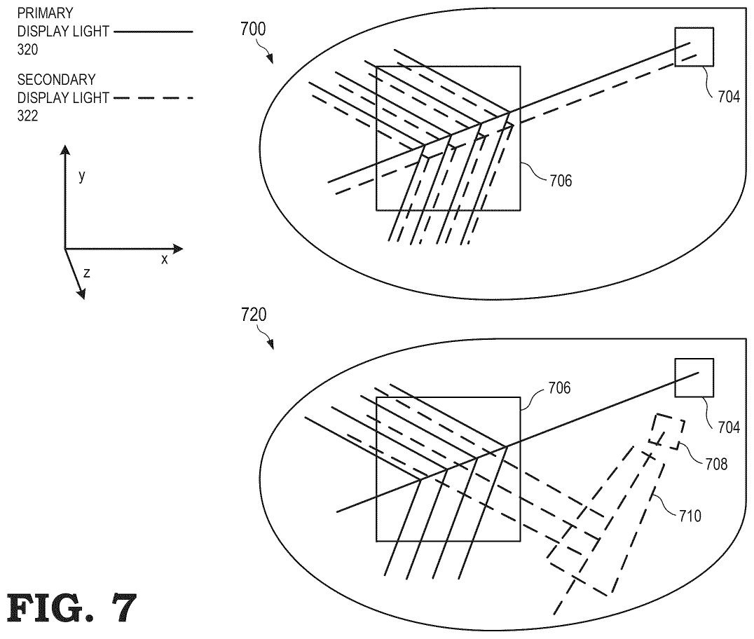

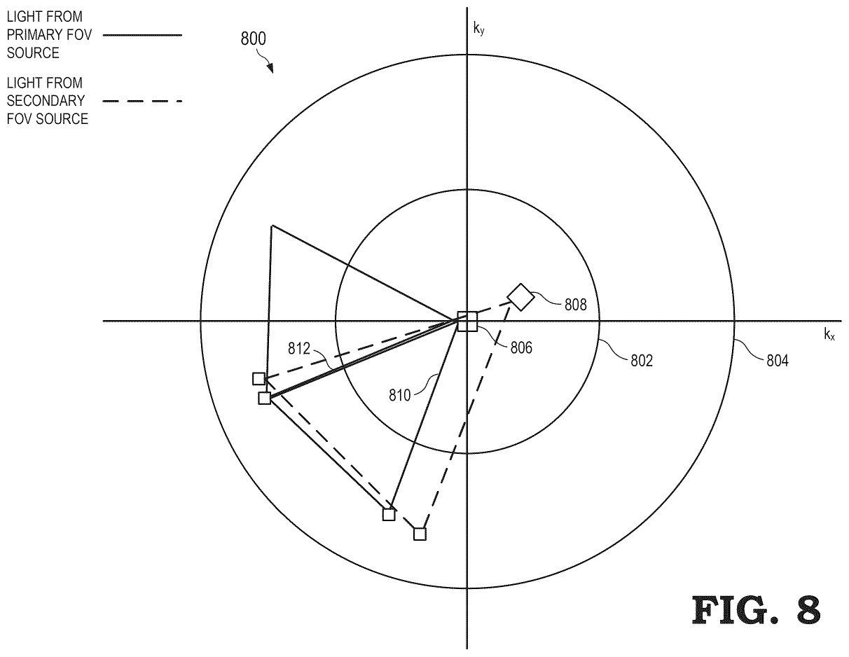

FIGS. 7 and 8 together illustrate an example of behavior of component wavelengths of primary and secondary display light traveling through waveguide systems employing one or more 1D ICs and a 2D combined EPE/OC. FIG. 7 illustrates views of two waveguide systems 700, 720 with projection of component wavelengths of display light traveling between a one-dimensional IC and a two-dimensional EPE/OC in accordance with some embodiments. Waveguide system 700 includes a single 1D IC 704 to direct both primary display light 320 and secondary display light 322 into the waveguide system 700 to a 2D combined EPE/OC 706, which expands and outcouples the primary display light 320 to a primary FOV and the secondary display light 322 to a secondary FOV.

Waveguide system 720 includes an additional 1D IC 708 and 1D EPE 710 to guide the secondary display light 322 to the 2D combined EPE/OC 706. In some embodiments, the addition of the 1D IC 708 and 1D EPE 710 to the optical path of the secondary display light 322 increases the brightness of the secondary display light 322 that is output from the 2D combined EPE/OC 706 to the secondary FOV.

FIG. 8 is a k-space diagram of the component wavelengths of display light traveling through the waveguides of FIG. 7 in accordance with some embodiments. Primary display light enters the waveguide systems 700, 720 from an external position 806, which is included in the space depicted within the inner refractive boundary 802. The 2D combined EPE/OC 706 produces two k-vectors 810, 812, changing the direction of light within the waveguide and diffracting the light into air to produce an outcoupling function, such that the color components are directed along two or more paths within a volume the space depicted between inner refractive boundary 802 and outer refractive boundary 804 and are then redirected to exit the double waveguide system and return to the external space within inner refractive boundary 802.

In the illustrated example, display light from the secondary display enters each of the waveguide systems 700, 720 from an external position 808 which is offset from the external position 806 and is included in the space depicted within inner refractive boundary 802. The secondary display light is directed along two or more paths within a volume of each of the waveguide systems 700, 720 and is then redirected to exit the double waveguide system and return to the external space within the refractive boundary 802 at an area offset from the primary display light.

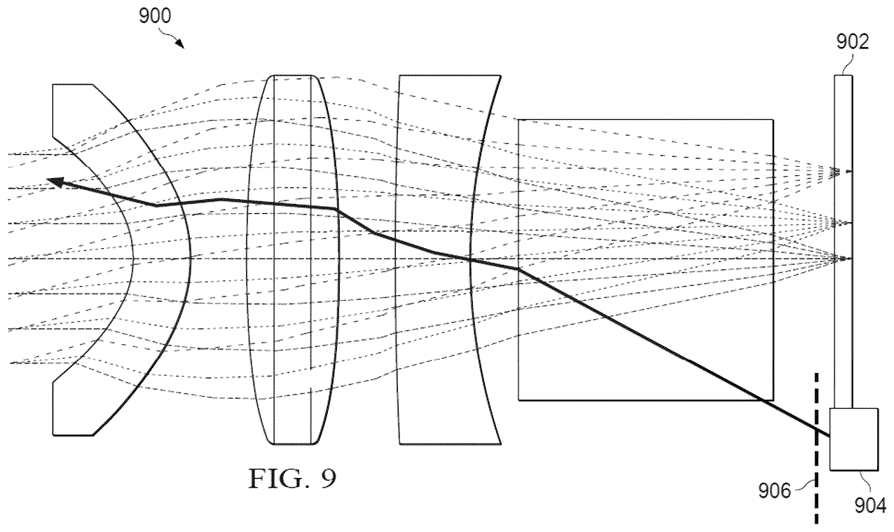

FIG. 9 is a diagram illustrating display light projected from a primary display 902 and a secondary display 904 through projection lens optics 900 to create an exit pupil at the IC of a waveguide system in accordance with some embodiments. The primary display 902 in combination with the projection lens optics 900 emits red, green, and blue light into a range of angles (field points), which constitute the primary FOV. The secondary display 904, which is laterally offset from the primary display 902, emits light at different angles that lie beyond the primary FOV. The red, green, and blue light from the primary display 902 is guided through the projection lens optics 900 to a first exit pupil (not shown), and the red light from the secondary display 904 is guided through the projection lens optics 900 to a second exit pupil that is displaced in angle from the first pupil.

In the illustrated example, a reticle or mask 906 is placed between the secondary display 904 and the projection lens optics 900. The reticle or mask 906 adds information to the red light emitted from the secondary display 904. Thus, rather than displaying only an indicator light, the secondary FOV includes information such as a “recording” icon. In another example, the reticle or mask 906 is an icon such as a low battery symbol in some embodiments. In some embodiments, multiple light sources such as VCSELs, LEDs, masks, and/or hologram layers are used to generate content for viewing at the secondary FOV. In yet other embodiments, the secondary display 904 is a micro-display that generates dynamic content for viewing at the secondary FOV.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A near-eye display system, comprising:
a waveguide system;
a first display to emit display light comprising a first color to enter a waveguide system at a first set of input angles corresponding to a first field of view; and
a second display displaced from the first display to emit display light comprising a second color to enter the waveguide system at a second set of input angles corresponding to a second field of view, wherein the waveguide system is configured to direct display light from the first display to the first field of view and to direct display light from the second display to the second field of view.

2. The near-eye display system of claim 1, wherein the first field of view is displaced from the second field of view.

3. The near-eye display system of claim 1, wherein the second display is further configured to emit display light comprising the first color.

4. The near-eye display system of claim 1, wherein the waveguide system comprises:
a first waveguide configured to guide display light from the first display to the first field of view and guide display light from the second display to the second field of view; and
a second waveguide configured to guide display light from the first display to the first field of view.

5. The near-eye display system of claim 1, wherein the waveguide system comprises:
a first incoupler to direct display light from the first display into the waveguide system; and
a second incoupler displaced from the first incoupler to direct display light from the second display into the waveguide system.

6. The near-eye display system of claim 5, wherein the waveguide system comprises:
an outcoupler to couple display light from the first incoupler and the second incoupler out of the waveguide system.

7. The near-eye display system of claim 6, wherein
the first incoupler comprises a one-dimensional grating;
the second incoupler comprises a one-dimensional grating; and
the outcoupler comprises a two-dimensional grating to expand display light from the first incoupler and the second incoupler and couple the display light out of the waveguide system.

8. The near-eye display system of claim 1, further comprising:
a reticle disposed between the first display and the waveguide system to add information to the display light.

9. A method, comprising:
emitting display light comprising a first color from a first display to enter a waveguide system at a first set of input angles corresponding to a first field of view;
emitting display light comprising a second color from a second display to enter the waveguide system at a second set of input angles corresponding to a second field of view; and
directing display light from the first display through the waveguide system to the first field of view; and
directing display light from the second display through the waveguide system to the second field of view.

10. The method of claim 9, wherein the first field of view is displaced from the second field of view.

11. The method of claim 9, further comprising:
emitting display light comprising the first color from the second display.

12. The method of claim 9, further comprising:
directing display light from the first display and the second display into a first waveguide of the waveguide system through a first incoupler;
coupling display light from the first display out of the first waveguide through a first outcoupler to the first field of view and coupling display light from the second display out of the first waveguide through the first outcoupler to the second field of view;
directing display light from the first display into a second waveguide of the waveguide system through a second incoupler; and
coupling display light out of the second waveguide through a second outcoupler to the first field of view.

13. The method of claim 9, further comprising:
directing display light from the first display into the waveguide system through a first incoupler; and
directing display light from the second display into the waveguide system through a second incoupler displaced from the first incoupler.

14. The method of claim 13, further comprising:
coupling display light from the first incoupler and the second incoupler out of the waveguide system through an outcoupler.

15. A waveguide system, comprising:
a waveguide to direct primary display light from a primary display to a primary field of view and to direct secondary display light from a secondary display to a secondary field of view offset from the primary field of view.

16. The waveguide system of claim 15, wherein the primary display light comprises red light, green light, and blue light, and the secondary display light comprises one of red light, green light, and blue light.

17. The waveguide system of claim 15, further comprising:
a first waveguide configured to:
direct green and blue display light from the primary display to the primary field of view; and
direct red display light from the secondary display to the secondary field of view; and
a second waveguide configured to direct red display light from the primary display to the primary field of view.

18. The waveguide system of claim 15, further comprising:
a first incoupler to direct the primary display light from the primary display into the waveguide system; and
a second incoupler displaced from the first incoupler to direct the secondary display light from the secondary display into the waveguide system.

19. The waveguide system of claim 18, further comprising:
an outcoupler to couple the primary and secondary display light from the first incoupler and the second incoupler out of the waveguide system.

20. The waveguide system of claim 19, wherein:
the first incoupler comprises a one-dimensional grating;
the second incoupler comprises a one-dimensional grating; and
the outcoupler comprises a two-dimensional grating to expand the primary display light from the first incoupler and the second incoupler and couple the primary display light out of the waveguide system.
